(19) United States
(12) Patent Application Publication
(10) Pub. No.: US 2019/0248099 A1
(43) Pub. Date: Aug. 15, 2019

(54) METHOD FOR MANUFACTURING AN EQUIPMENT PANEL FOR A RAILWAY VEHICLE

(71) Applicant: ALSTROM Transport Technologies, Saint-Ouen (FR)

(72) Inventors: Francis LANGLOIS, Faumont (FR); Yohan LEBER, Valenciennes (FR); Zeeshan Malik MOHAMMAD, Sevran (FR)

(21) Appl. No.: 16/271,006

(22) Filed: Feb. 8, 2019

(30) Foreign Application Priority Data
Feb. 14, 2018 (FR) 18 51237

(51) Int. Cl. B32B 3/12; B61D 37/00; B32B 27/08; B32B 7/12

(52) U.S. Cl. CPC B32B 3/12; B61D 37/00; B32B 2250/40; B32B 7/12; B32B 2250/03; B32B 27/08

(57) ABSTRACT

The equipment panel includes a cellular core inserted between first and second skins. The method includes: assembling the first skin with the cellular core, the cellular core being arranged such that its cells extend perpendicular to the first skin; filling a peripheral zone of the cellular core with a resin; assembling the second skin with the cellular core; polymerizing the resin, thus securing the cellular core with the first and second skins; machining a contour of the panel, the contour being defined in a plane parallel to the first and/or second skins, and machined in the peripheral zone; and assembling a lateral skin on the edge of the panel with the machined contour.

The present invention relates to a method for manufacturing an equipment panel for a railway vehicle.

Such a panel is for example intended to manufacture a table equipping the railway vehicle, a foldable tray equipping such a table, or any equipment requiring a flat panel whose edges are intended to receive or not receive a finish.

The panel usually includes a cellular core inserted between first and second parallel skins. The contour of the panel is machined to give it a predetermined shape. Then, the peripheral side wall of the panel (also called “edge”) is assembled with a molded part.

The manufacture of such a panel requires many expensive operations.

The invention in particular aims to reduce the production time and the cost of such a panel.

To that end, the invention in particular relates to a method for manufacturing an equipment panel of a railway vehicle, the panel including a cellular core inserted between first and second skins, characterized in that it includes:
a step for providing the first skin,
a first step for assembling the first skin with the cellular core, the cellular core being arranged such that its cells extend substantially perpendicular to the first skin,
a step for filling a peripheral zone of the cellular core with a resin,
a second step for assembling the second skin with the cellular core,
a step for polymerization of the resin, thus securing the cellular core with the first and second skins,
a step for machining a contour of the panel, the contour being defined in a plane parallel to the first and/or second skins, and machined in the peripheral zone.

The resin is introduced into the peripheral zone, filling the cells of said peripheral zone. Thus, said resin makes it possible both to provide the assembly of the cellular core with the first and second skins, and also to reinforce the cellular core.

Furthermore, the contour being machined in said same peripheral zone, the polymerized resin forms, in the machined contour, a relatively continuous surface, which can form a finish directly or which allows a simple assembly of a lateral skin with the edge of the panel. This lateral skin can also be glued easily on the edge of the panel.

As a result, the manufacturing time of the panel is significantly reduced relative to the implementation time of a manufacturing method of the state of the art.

The manufacturing method according to the invention may further include one or more of the following features, considered alone or according to any technically possible combinations.
The manufacturing method includes, after the machining step, a third step for assembling a lateral skin on an edge of the panel with the machined contour.
The manufacturing method includes, after the third assembly step, a step for cutting the lateral skin using a router plane.
The third assembly step includes gluing the lateral skin on the edge of the panel.
The manufacturing method includes, after the third assembly step, a step for inserting at least one fastening element in the edge of the panel.
The insertion step includes machining a location for receiving the fastening element in the edge, then securing, for example by gluing, the fastening element in the receiving location.
A stencil is arranged on the cellular core before the filling step, the stencil delimiting the peripheral zone.
The first assembly step is carried out by simply placing the cellular core on the first skin.

The invention also relates to an equipment panel for a railway vehicle, including a cellular core inserted between first and second skins, characterized in that it has a peripheral zone in which the cellular core is filled with resin, the peripheral contour of the panel being machined in said peripheral zone, such that the polymerized resin forms a substantially continuous surface in said machined contour.

This panel is derived directly from the manufacturing method as previously defined.

Advantageously, the panel includes a lateral skin assembled to an edge of said panel, the lateral skin being at least partly secured in contact with the resin of the peripheral zone, on said substantially continuous surface.

The invention will be better understood using the following description, provided solely as an example and done in reference to the appended figures, in which:

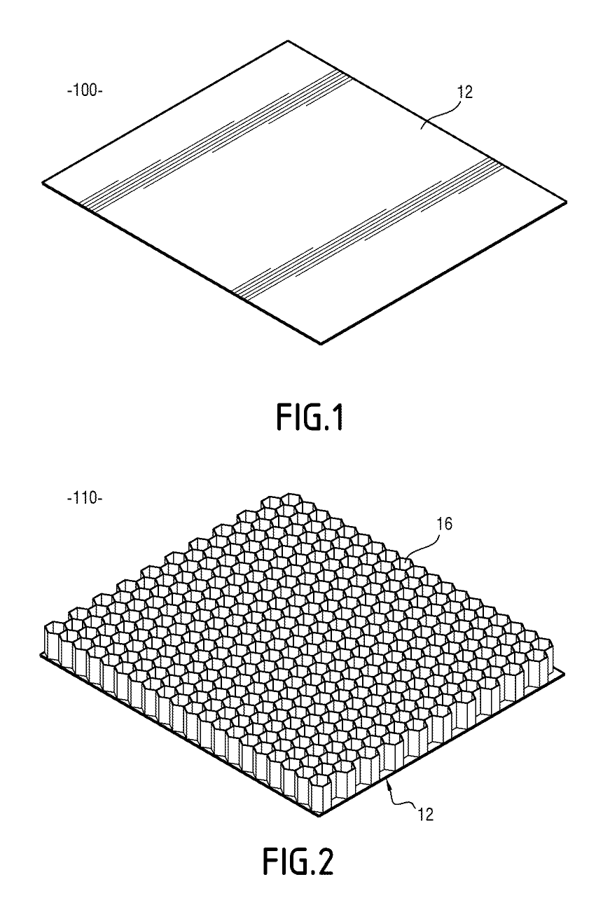

FIG. 1 is a perspective view of a first skin in a first manufacturing step of a method according to one example embodiment of the invention,

FIG. 2 is a perspective view of the first skin of FIG. 1 assembled with a cellular core in a second manufacturing step of the method,

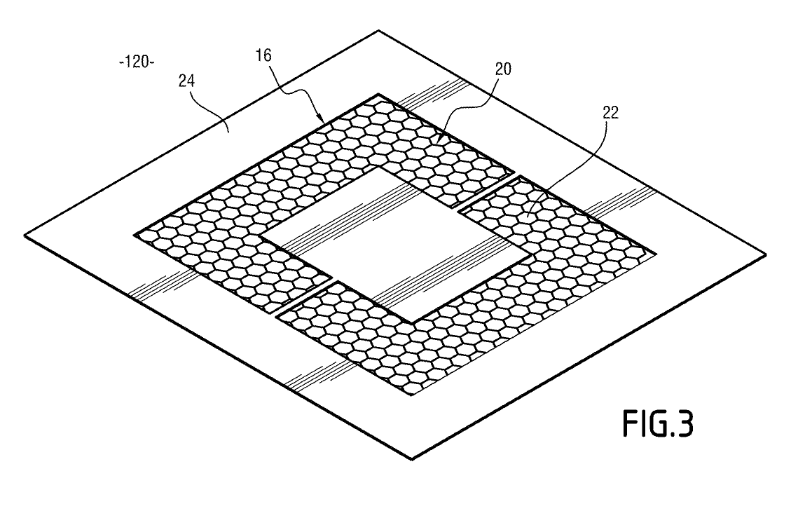

FIG. 3 is a perspective view of a panel during a third manufacturing step of the method,

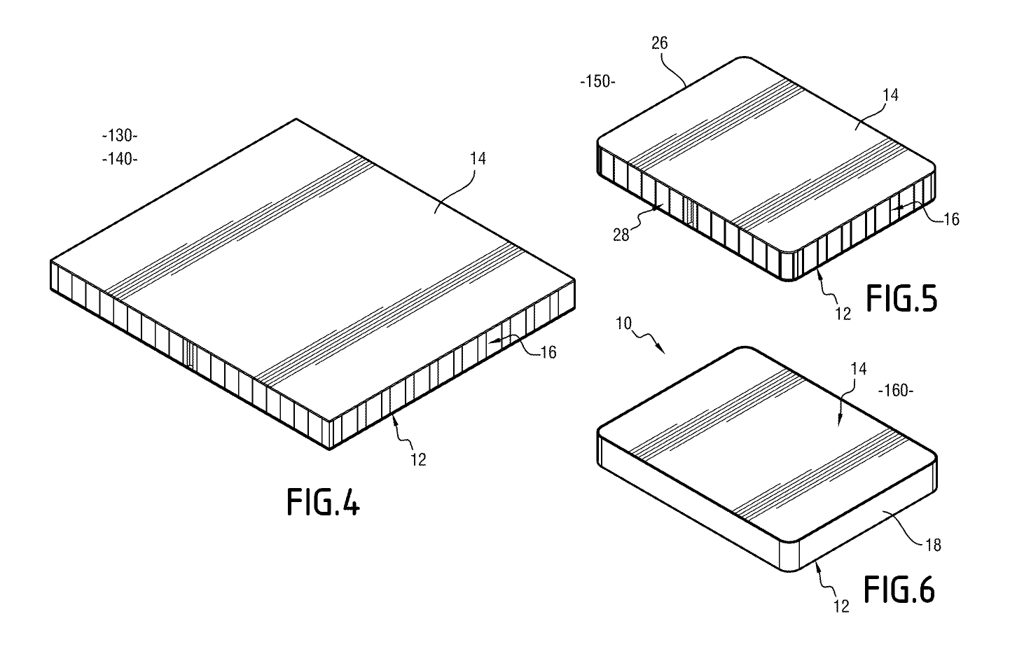

FIG. 4 is a perspective view of the panel during a fourth manufacturing step of the method,

FIG. 5 is a perspective view of the panel during a fifth manufacturing step of the method,

FIG. 6 is a perspective view of the panel during a sixth manufacturing step of the method.

The completed panel derived from the method according to the invention is shown in FIG. 6, and will be designated by general reference 10. Such a panel 10 is for example intended to form a railway vehicle table, equipping a passenger room, or a folding tray of such a table or any flat panel intended for the interior layout.

The panel 10 includes a first skin 12 and a second skin 14 that are preferably parallel, between which a cellular core 16 (visible in FIG. 2) is inserted. In the described example, the panel 10 also includes a lateral skin 18, extending perpendicular to or forming any angle with the first 12 and second 14 skins, surrounding an edge of the panel 10, i.e., surrounding a peripheral side wall of the panel 10.

The method for manufacturing the panel 10 will now be described, the different steps of this method being shown in FIGS. 1 to 6.

As shown in FIG. 1, the manufacturing method includes a step 100 for providing the first skin 12.

As shown in FIG. 2, the manufacturing method next includes a first step 110 for assembling the first skin 12 with the cellular core 16. More particularly, during this first assembly step 110, the cellular core 16 is placed on the first skin 12, said cellular core 16 being arranged such that its cells extend perpendicular to the first skin 12. In other words, during this first assembly step 110, the cellular core 16 is arranged such that a central axis around which each cell extends is oriented perpendicular to the first skin 12.

As shown in FIG. 3, the manufacturing method next includes a step 120 for filling a peripheral zone 20 of the cellular core 16 with a resin 22.

To that end, a stencil 24 is advantageously arranged on the cellular core 16 before filling, said stencil 24 delimiting the peripheral zone 20.

Alternatively, the entire cellular core 16 is filled with resin 22.

The cells being perpendicular to the first skin 12, the resin fills said cells, between the first skin 12 to the upper end of said cells.

As shown in FIG. 4, the method next includes a second step 130 for assembling the second skin 14 with the cellular core 16. Of course, in the case where the stencil 24 has been used, the latter is removed before the assembly with the second skin 14.

The method next includes a step 140 for polymerization of the resin, thus securing the cellular core 16 filled with resin 22 with the first skin 12 on the one hand and the second skin 14 on the other hand. This polymerization is for example done by heating the resin.

The method next includes a step 150 for machining a contour 26 of the panel 10. This contour 26, shown in FIG. 5, is defined in a plane parallel to the first 12 and/or second 14 skins, and machined in the peripheral zone 20.

The machining of this contour 26 makes it possible to give the panel 10 its desired predefined shape.

The machining being done in the peripheral zone 20, the cut cells are filled with polymerized resin. As a result, the edge 28 of the panel 10 is formed by a substantially continuous peripheral surface. This peripheral surface 28 is suitable for receiving the third skin 18, for example by simple gluing. The side skin 18 is therefore at least partially secured in contact with the resin 22 of the peripheral zone 20.

Thus, the method next advantageously includes a third step 160 for assembling the lateral skin 18 on the edge 28 of the panel 10 to the machined contour 26. The lateral skin 18 is also called “edge strip”.

It should be noted that the contour 26 may have any desired shape, the method according to the invention allowing an easy assembly of the lateral skin 18 with the edge 28 irrespective of the shape of the contour 26.

Advantageously, the method next includes a step for cutting the lateral skin 18 with a router plane, such that the lateral skin 18 is correctly flush with the first 12 and second 14 skins.

It clearly appears that the method according to the invention makes it possible to simplify the edging of the panel 10. In particular, the edge strip 18 is more cost-effective to implement, purchase and assemble, than the molded parts typically assembled to the edge of the panels of the state of the art. Furthermore, the method according to the invention is easier to implement than a method of the state of the art.

Lastly, the peripheral zone 20 being filled with resin, its structural rigidity is greater than that of a panel of the state of the art.

If necessary, the method further includes a step for inserting at least one fastening element into the edge 28 of the panel 10.

For example, if the panel 10 forms a folding tray, the fastening element is a hinge connecting said panel 10 to another panel forming a table. This other panel is preferably also made using the method according to the invention.

The high structural rigidity of the peripheral zone of the panel 10 allows an effective assembly with the fastening element.

This fastening element can be assembled traditionally to the panel 10. For example, a location for this fastening element is machined in the edge 28 of the panel 10, and the fastening element is glued in said location.

It will be noted that the invention is not limited to the embodiment previously described, but could assume various complementary alternatives.

In particular, the contour 26 could assume any other conceivable shape, and the panel 10 could be intended for another piece of equipment of the railway vehicle.

Furthermore, according to one alternative, the panel 10 does not include an edge strip 18. Indeed, the polymerized resin forms, in the machined contour of the peripheral zone, a relatively continuous surface, which then in this case directly forms a finish.

1. A manufacturing method for manufacturing an equipment panel of a railway vehicle, the equipment panel including a cellular core inserted between first and second skins, wherein it includes:
providing the first skin,
assembling the first skin with the cellular core, the cellular core being arranged such that its cells extend perpendicular to the first skin,
filling a peripheral zone of the cellular core with a resin,
assembling the second skin with the cellular core,
polymerizing the resin, thus securing the cellular core with the first and second skins,
machining a contour of the panel, the contour being defined in a plane parallel to the first and/or second skins, and machined in the peripheral zone.

2. The manufacturing method according to claim 1, including, after machining the contour, assembling a lateral skin on an edge of the panel with the machined contour.

3. The manufacturing method according to claim 2 including, after assembling the lateral skin on the edge, cutting the lateral skin using a router plane.

4. The manufacturing method according to claim 2, wherein the assembling of the lateral skin includes gluing the lateral skin on the edge of the panel.

5. The manufacturing method according to claim 2, including, after assembling the lateral skin on the edge, inserting at least one fastening element in the edge of the panel.

6. The manufacturing method according to claim 5, wherein the inserting includes machining a location for receiving the fastening element in the edge, then securing the fastening element in the receiving location.

7. The manufacturing method according to claim 1, wherein a stencil is arranged on the cellular core before filling the peripheral zone with the resin, the stencil delimiting the peripheral zone.

8. The manufacturing method according to claim 1, wherein the assembling of the first skin with the cellular core is carried out by simply placing the cellular core on the first skin.

9. An equipment panel for a railway vehicle, including a cellular core inserted between first and second skins, wherein the equipment panel has a peripheral zone in which the cellular core is filled with resin, a peripheral contour of the panel being machined in said peripheral zone, such that the resin, when polymerized, forms a continuous surface in said machined contour.

10. The equipment panel according to claim 9, including a lateral skin assembled to an edge of said equipment panel, the lateral skin being at least partly secured in contact with the resin of the peripheral zone, on said continuous surface.
